(19) United States
(12) Patent Application Publication
(10) Pub. No.: US 2026/0309573 A1
(43) Pub. Date: Oct. 8, 2026

(54) GASEOUS LEAK DETECTION SYSTEM AND ASSOCIATED METHODS

(71) Applicant: TrelliSense, Inc., Boulder, CO (US)

(72) Inventors: Andrew D. Sappey, Boulder, CO (US); Bernard P. Masterson, Louisville, CO (US)

(21) Appl. No.: 19/479,536

(22) PCT Filed: May 7, 2024
(86) PCT No.: PCT/US2024/028177

§ 371 Date: Oct. 28, 2025

Related U.S. Application Data
(60) Provisional application No. 63/500,772, filed on May 8, 2023.

(51) Int. Cl. G01M 3/20; G01J 3/22; G01J 3/28

(52) U.S. Cl. CPC G01M 3/207; G01J 3/22; G01J 3/2803

(57) ABSTRACT

A gaseous leak detection system includes at least one spectrometer configured to measure a first intensity of light from a light source and generate a leak detection data feed. The at least one spectrometer is emplaced at a leak detection location, a laser heterodyne radiometer (LHR), which is configured to measure an absorption lineshape of light from the light source and generate a background data feed. The LHR is emplaced at a background detection location. A computing device is configured to analyze the leak detection data feed and the background data feed to detect the presence of a gas leak. In embodiments, the spectrometer includes at least one of a diffraction grating, an echelle grating in a Littrow configuration, a photodiode and a wavelength scanning element. In embodiments, the photodiode is an indium gallium arsenide (InGaAs) photodiode array.

### REFERENCE TO RELATED APPLICATIONS

This application is a National Stage of International Application No. PCT/US24/28177, filed on 2024-05-07 which claims the benefit of US Provisional Pat. App. No. 63/500,772, filed 2023-05-08 and titled “Detector and Methods for Gaseous Leak Detection,” which is incorporated hereby in its entirety by reference.

### FIELD OF THE INVENTION

The disclosed subject matter relates to a gaseous leak detection system and methods for gaseous leak detection. Particularly, the present disclosed subject matter is directed to a detection system and methods for gaseous methane leak detection utilizing the sun as a signal light source.

### DESCRIPTION OF RELATED ART

Industrial gaseous leak detection is extremely important due to both safety concerns and more recently due to concerns about the release of climate-change-driving greenhouse gases (GHGs) such as methane. Methane is a highly potent GHG with approximately 80 times warming power of CO₂ during its lifetime in the atmosphere and represents a significant fraction (~30%) of human-caused climate change, according to the United Nations Environment Programme. The lifetime of methane in the atmosphere is about 10 years, thus methane emissions reductions represent low-hanging fruit in combatting climate change as any reductions now would start paying dividends within 10 years.

Because of the interest in methane emissions reductions from oil and gas infrastructure, landfills, coal mines, anaerobic digestion facilities, and agricultural operations, multiple methane leak-sensing options have been developed/deployed. These can be conveniently grouped according to areal coverage. On the largest scale, satellites using hyperspectral imaging can detect methane leaks from orbit. However, they require full sunlight to work, struggle to account for changes in surface albedo, are expensive to develop and launch, can only detect very large ultra-emitter leaks, have a limited revisit cadence, and often have limited spatial resolution. Newer satellites have somewhat higher spatial resolution but are still limited to a 30×30 meter pixel size. Constellations of satellites can address the revisit rate to some extent, although at a large cost.

At a slightly smaller scale in terms of areal coverage, airborne technologies, such as hyperspectral imagers and gas mapping light detection and ranging (LIDAR), are designed to fly on fixed-wing aircraft. They have improved resolution and sensitivity, but a single measurement campaign can cost upwards of $25 k and most companies would not fund a campaign more than a few times a year. Thus, leaks can exist for a long time before discovery and mitigation occurs.

Technologies such as Tunable Diode Laser Spectroscopy (TDLAS) provide continuous coverage but over a much-reduced area. Typically, these technologies are much more expensive, costing anywhere from $30 k to more than $150 k depending on the type of laser source used, and cover a few 10's of kilometers, usually two at most. Other continuous sensing technologies such as metal oxide semiconductors are fairly inexpensive (~$10 k/sensor installed) but they are often inaccurate, drift, require frequent calibration, and need to be replaced every few years. They have largely fallen out of favor because of their unreliability and high total cost of ownership.

There is still a significant need for ground-based, accurate, sensitive, and inexpensive methane monitoring technologies that are continuous or nearly continuous with daily updates.

### SUMMARY OF THE INVENTION

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a gaseous leak detection system including at least one spectrometer configured to measure a first intensity of light from a light source and generate a leak detection data feed, wherein the spectrometer is emplaced at a leak detection location, a laser heterodyne radiometer (LHR), wherein the LHR is configured to measure an absorption lineshape of light from the light source and generate a background data feed, wherein the LHR is emplaced at a background detection location, and a computing device, wherein the computing device is configured to analyze the leak detection data feed and the background data feed to detect the presence of a gas leak.

The disclosed subject matter also includes methods for detecting gaseous leaks including measuring a first intensity of light from a light source using a spectrometer emplaced at a leak detection location, generating a leak detection data feed based on the first intensity of light, measuring an absorption lineshape of light from the light source using a laser heterodyne radiometer (LHR) emplaced at a background detection location, generating a background data feed based on the absorption lineshape of the light, analyzing, by a computing device, the leak detection data feed and the background data feed, and generating a signal based on the analysis.

In an embodiment, a gaseous leak detection system includes at least one spectrometer configured to measure a first intensity of light from a light source and generate a leak detection data feed. The spectrometer is emplaced at a leak detection location. The system further includes a laser heterodyne radiometer (LHR), wherein the LHR is configured to measure an absorption lineshape from the light source and generate a background data feed, wherein the LHR is emplaced at a background detection location.

In certain embodiments, the system further includes a computing device, wherein the computing device is configured to analyze the leak detection data feed and the background data feed to detect the presence of a gas leak.

In embodiments, the at least one spectrometer includes at least one of a diffraction grating and an echelle grating in a Littrow configuration.

In embodiments, the at least one spectrometer includes a photodiode and a wavelength scanning element. In certain embodiments, the photodiode is an indium gallium arsenide (InGaAs) photodiode array.

In embodiments, the spectrometer is configured to be mounted on a mobile vehicle including at least one of a fixed-wing aircraft, drone, and multicopter. In certain embodiments, the mobile vehicle is one of an autonomous vehicle and a piloted vehicle.

In embodiments, a method for detecting gaseous leaks includes measuring a first intensity of light from a light source using at least one spectrometer emplaced at a leak detection location, generating a leak detection data feed based on the first intensity of light, measuring an absorption lineshape of light from the light source using a laser heterodyne radiometer (LHR) emplaced at a background detection location, generating a background data feed based on the absorption lineshape of the light from the light source, analyzing, by a computing device, the leak detection data feed and the background data feed, and generating a signal based on the analyzing.

In embodiments, the methane plume is located at the leak detection location, and the background data feed includes presence of background methane. In certain embodiments, the background data feed includes at least one of historical background data feed and contemporaneous background data feed, and the background data feed includes location data and time data corresponding to the background detection location. In certain embodiments, analyzing by the computing device includes at least one of removing the contemporaneous background data feed from the leak detection feed and removing the historical background data feed from the leak detection data feed.

In embodiments, analyzing the leak detection data feed and the background detection data feed includes utilizing at least one machine learning algorithm to compare the leak detection data feed and the background detection data feed at the leak detection location to historical data at the leak detection location In embodiments, the signal is one of a detection signal and a non-detection signal, and analyzing the leak detection data feed and the background detection data feed includes using at least one machine learning algorithm to correlate the leak detection data feed and the background detection data feed.

In embodiments, the computing device is configured to receive an environmental data feed including at least one of wind direction, wind velocity, temperature, and humidity. In certain embodiments, the method further includes determining a location of a gaseous leak based on the environmental data feed using at least one of triangulation and inversion. In certain embodiments, the method includes receiving the environmental data feed from multiple sensors, processing at least one of the environmental data feed, leak detection data feed, and background detection data feed using inversion algorithms, and determining a quantity of gas leaked in a suitable unit based on the leak data feed, the background data feed, and the environmental data feed so processed.

In embodiments, a gaseous leak detection system includes a spectrometer placed at a potential leak location, the spectrometer including a photodiode and at least one of a diffraction grating and an echelle grating in a Littrow configuration, a laser heterodyne radiometer (LHR) placed at a background detection location, and a computing device configured for receiving and analyzing data from the spectrometer and the LHR. The spectrometer is configured to generate a leak detection data feed from light intensity measured from a light source, the LHR is configured to generate a background data feed from an absorption lineshape measured from the light source, and the computing device is configured for receiving and analyzing the leak detection data feed and the background data feed to determine presence of a gas leak.

In certain embodiments, the light source is at least one of sun, moon, a star, a planet, and an artificial source of electromagnetic radiation.

In embodiments, the system further includes a sensor system for generating an environmental data feed including at least one of wind direction, wind velocity, and humidity, and the computing device is further configured to receive the environmental data feed from the sensor system. In embodiments, the computing device is further configured to use the leak detection data feed, the background data feed, and the environmental data feed to determine at least one of a location and a quantity of gas leaked from the gas leak, if determined to be present.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is a schematic representation of the gaseous leak detection system and methods for gaseous leak detection in accordance with the disclosed subject matter.

FIG. 2A is a schematic representation of an exemplary embodiment of a spectrometer in accordance with the disclosed subject matter.

FIG. 2B is an exemplary representation of an absorption of spectrum of electromagnetic radiation associated with water and methane in accordance with the disclosed subject matter.

FIG. 3 is a schematic view of the gaseous leak detection system and methods for gaseous leak detection shown in FIG. 1.

FIG. 4 is a schematic view of the gaseous leak detection system and methods for gaseous leak detection with a spectrometer array.

FIG. 5 is a schematic view of the gaseous leak detection system and methods for gaseous leak detection mounted on a ground-based drone.

FIG. 6 is a schematic view of the gaseous leak detection system and methods for gaseous leak detection mounted on an aerial drone.

FIG. 7 is a flow chart depicting a method for gaseous leak detection in accordance with the disclosed subject matter.

FIG. 8 depicts a computing node according to an embodiment of the present disclosure.

### DETAILED DESCRIPTION OF THE INVENTION

Reference will now be made in detail to exemplary embodiments of the disclosed subject matter, an example of which is illustrated in the accompanying drawings. The method and corresponding steps of the disclosed subject matter will be described in conjunction with the detailed description of the system.

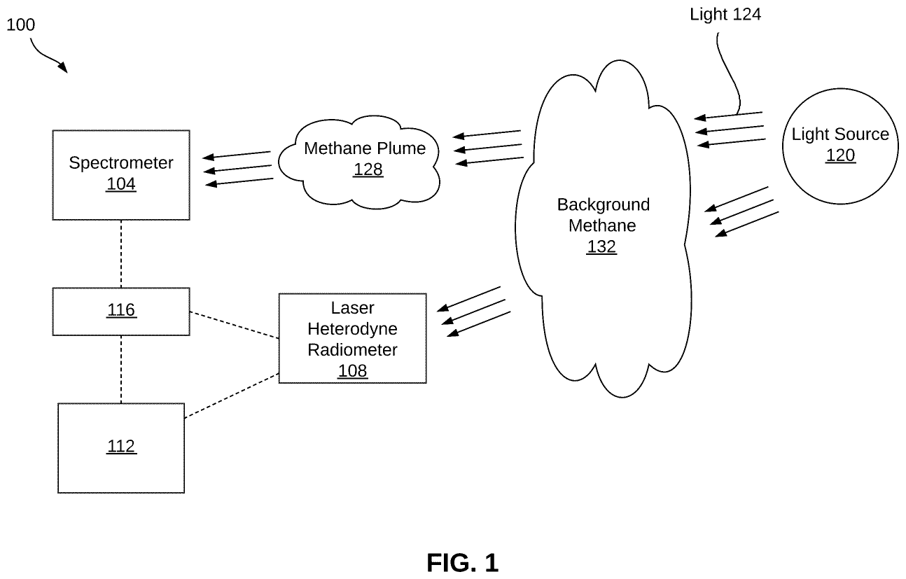

The methods and systems presented herein may be used for a gaseous leak detection system. The disclosed subject matter is particularly suited for a gaseous leak detection system and methods for gaseous methane leak detection utilizing the sun as a signal light source. For purpose of explanation and illustration, and not limitation, an exemplary embodiment of the gaseous leak detection system in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures.

As shown in FIG. 1, a schematic representation of a gaseous leak detection system 100 is shown. The system 100 includes a grating-based spectrometer 104. Grating-based spectrometer 104 may intake and analyze light 124 (represented by arrows) from a light source 120 after it transits a methane plume 128. The methane plume 128 may be located at some altitude above a terrestrial landscape, such as in Earth's atmosphere at some altitude measured from sea level. In various embodiments, light 124 may be visible spectrum light. In various embodiments, light 124 may be ultraviolet, infrared, near-infrared, or another type of electromagnetic radiation. In various embodiments, light source 120 may be the sun, moon, one or more other stars, or one or more artificial sources of electromagnetic radiation.

System 100 may include one or more grating-based spectrometers 104. In various embodiments, spectrometer 104 may be configured to stare at the light source 120 throughout its operation. In various embodiments, spectrometer 104 may be configured to track the light source through the motion of the light source 120, such as the path of the sun through the sky in a day. In various embodiments, spectrometer 104 may be configured to periodically target the light source 120 throughout its operation. In various embodiments, system 100 may include one spectrometer 104 emplaced at a leak detection location or an array of grating-based spectrometers 104 emplaced at one or a multitude of leak detection locations. Each leak detection location may include one or more spectrometers 104. In various embodiments, more than one spectrometer 104 may be used at the same leak detection location. In various embodiments, more than one spectrometer 104 may be used at a plurality of leak detection locations, such as one spectrometer at each of two leak detection locations. In various embodiments, an array of spectrometers 104 may be utilized at one or more leak detection locations.

In various embodiments, spectrometer 104 may be an echelle grating spectrometer. In various embodiments, the echelle grating may include any number of reflective facets with widths close to the wavelength of the diffracted light. The light of a single wavelength in a standard grating at normal incidence is diffracted to the central zero order and successive higher orders at specific angles, defined by the grating density/wavelength ratio and the selected order.

The angular spacing between higher orders monotonically decreases and higher orders can get very close to each other, while lower ones are well separated. The intensity of the diffraction pattern can be altered by tilting the grating. With reflective gratings, the reflective portion can be tilted, or “blazed” to scatter a majority of the light into a direction of interest (and into a specific diffraction order). For multiple wavelengths the same is true; however, in that case it is possible for longer wavelengths of a higher order to overlap with the next order(s) of a shorter wavelength, which is usually an unwanted side effect.

In echelle gratings, however, this behavior is deliberately used and the blaze is optimized for multiple overlapping higher orders. In various embodiments, the echelle grating spectrometer may include one or more, perpendicularly mounted dispersive element (grating or prism) is inserted as an “order separator” or “cross disperser” into the beam path. In various embodiments, the spectrum consists of stripes with different, but slightly overlapping, wavelength ranges that run across the imaging plane in an oblique pattern. It is exactly this behavior that helps to overcome imaging problems with broadband, high-resolution spectroscopic devices, as in the utilization of extremely long, linear detection arrays, or strong defocus or other aberrations, and makes the use of readily available 2D-detection arrays feasible, which reduces measurement times and improves efficiency. In various embodiments, spectrometer 104 may include one or more light filters. In various embodiments, the light filter, may be an interference filter, which is configured to limit the light entering the spectrometer 104 to the wavelength range of interest (e.g. 1650 to 1670 nm) thereby eliminating the possibility of overlapping orders.

The strengths of an echelle grating spectrometer include high dispersion and resolution in a relatively compact footprint. In various embodiments, spectrometer 104 may have a grating with ~158 lines/mm and a blaze angle of 70° operated in the 7^{th} order. In various embodiments, the grating has a blaze angle of 79° with 118 lines/mm and operates in 10^{th} order. One of ordinary skill will appreciate, after review of this disclosure, that this exemplary embodiment does not seek to limit the grating configurations, lines, blaze angles or any other aspect of the spectrometer 104. In various embodiments, spectrometer 104 may include a focal length of 20 cm. With a focal length of 20 cm, such a spectrometer 104 can provide a resolution of ~170,000 leading to a resolution unit of 10 pm at 1.66 microns in a compact unit about 7.5 cm×7.5 cm in cross section and about 25 cm long. In various embodiments, spectrometer 104 may include a corner cube to pass the signal light 120 from the grating twice thereby increasing spectral resolution without increasing the size of the spectrometer. A potential drawback of echelle gratings is their propensity to have significant changes in diffraction efficiency depending upon the polarization of the incoming light. This property may lead to lower spectrometer throughput. In cases with low available light levels, a non-echelle grating with worse resolution, but a higher efficiency may be a viable tradeoff.

Spectrometer 104 may be configured to generate a leak detection data feed. For the purposes of this disclosure, a “leak detection data feed” may be one or more electronic or optical signals corresponding to the intensity, absorption or another characteristic of the light from the sun. The leak detection data feed may be generated, fully or in part, by one or more components such as amplifiers, computing devices, power electronics or the like in order to generate an electrical or optical signal. In various embodiments, the leak detection data feed may be based on the absorption of light from the sun as it transits a gas leak, such as a methane plume. In various embodiments, the gas leak may be methane, hydrogen cyanide (HCN), hydrogen chloride (HCl), acetylene, ethylene, sulfur dioxide (SO₂) or a volatile organic compound (VOC), nitrous oxide (N₂O), amongst others. The leak detection data feed may be transmitted to a light detector, such as a diode as described herein. In various embodiments, a laser heterodyne radiometer (LHR) 108 may alternatively or additionally be utilized to measure the intensity of light and measure methane or another gas absorption with a higher resolution than the spectrometer 104.

In various embodiments, spectrometer 104 may include a 16-channel photodiode detector array with an 80 micron pixel size (100 micron pitch) in conjunction with a reimaging system or PIC-based waveguide array to reduce the pitch to about 12 microns yielding an effective linear dispersion of about 15 pm/pixel and a bandwidth coverage of 240 pm (16 pixels×15 pm) centered on the Q(6) feature of the near infrared (NIR) methane band. The width and resolution are well-matched to the spectral width of the methane Q(6) feature at atmospheric pressure (~185 pm across Q(6) from baseline to baseline). An order sorting filter may be used to remove light from higher orders (shorter wavelengths) from overlapping the desired 1.66 micron light.

Grating-based optical spectrometer 104 may use the sun as a light source 120. The spectral resolution of a grating-based spectrometer is much better than a filter-based method (e.g., ~0.01 nm versus 5-10 nm for typical filters) allowing better spectral fitting and quantification of methane plume 128. However, even with the improved spectral resolution, a grating-based spectrometer 104 of sufficiently small size to be practical may have limited spectral resolution and may struggle to remove the effect of background methane 132 at higher altitudes where low-pressure conditions cause the absorption lineshape to be very narrow, requiring a higher-resolution technique to quantify. Background or ambient methane is naturally occurring methane that is present at approximately 2 ppm throughout the lower altitudes of the atmosphere from ground level up to about 15 km.

One very significant advantage of a grating-based spectrometer 104 over a conventional LHR is the signal-to-noise ratio (SNR) behavior for long averaging times. LHRs using off-the-shelf distributed feedback (DFB) laser technology are known to follow the expected 1/\sqrt{t} averaging behavior for only a few seconds due to inherent instabilities in the DFB. These shortcomings may be overcome using known laser stabilization methods, but these add significant cost and complexity to an LHR. Thus, averaging for a long time to improve the signal-to-noise ratio of an LHR is not effective and limits the ultimate sensitivity that can be achieved. On the other hand, averaging for longer times with a grating-based spectrometer is highly effective at improving SNR, so smaller leaks can be located and quantified. In addition, a passive, grating-based spectrometer 104 will cost half or less than an LHR.

Spectrometer 104 may employ any form of grating, such as those known in the art. For example and without limitation, other types of diffraction gratings such as volume phase holographic (VPH) gratings, fiber Bragg gratings, ruled echellette gratings, holographic gratings, and virtually imaged phased arrays (VIPA) may be substituted with similar results. Likewise, architectures other than Littrow mount can be envisioned including a Czerny-Turner architecture and transmission grating designs without deviating from the scope of this disclosure.

In various embodiments, system 100 may include a linear photodiode array. Photodiode array may be any photodiode array as described herein. Photodiode array may be any multi-channel detector device configured to receive signals from one or more components as described herein, generate one or more absorption signals or visualizations based on these signals and transmit said generations to one or more users or systems. In various embodiments, a mechanical chopper may be utilized with the linear array detector in order to compensate for 1/f noise that may be present in the linear array detector or subsequent electronic components. In various embodiments, spectrometer 104 may include a single photodiode detector and a galvanometer, piezoelectric bender, or other electromechanical device in conjunction with a reflective optic to scan the wavelength-dispersed light across the photodiode. A mechanical or optical chopper is a device configured to periodically interrupt a light beam. In various embodiments, mechanical (or optical) chopper may be a variable frequency rotating disc chopper, fixed frequency tuning fork chopper, a fiber-optic switch, a MEMS mirror device, and/or optical shutters. Optical choppers, usually rotating disc mechanical shutters, may be utilized in combination with one or more lock-in amplifiers. The mechanical chopper is used to modulate the intensity of a light beam, and a lock-in amplifier is used to improve the signal-to-noise ratio.

To be effective, an optical chopper may be selected to have a stable rotating speed. In cases where the 1/f noise is the main problem, one would like to select the maximum chopping frequency possible. This characteristic is limited by the motor speed and the number of slots in the rotating disc, which is, in turn, limited by the disc radius and beam diameter.

In various embodiments, spectrometer 104 may include one or more other detectors including independent fiber-coupled indium gallium arsenide (InGaAs) photodiodes. In various embodiments, spectrometer 104 may include one or more two-dimensional arrays as light detectors.

With continued reference to FIG. 1, system 100 may include one or more computing devices 116. Computing device 116 may be consistent with any description of a computing device herein. Computing device 116 may be one or more processors communicatively connected to the spectrometers 104 and the LHRs 108. In various embodiments, computing device 116 may be configured to receive electrical or optical signals output by one or more of the spectrometers 104 and LHRs 108. Computing device 116 may be configured to generate commands and transmit those commands to one or more of the spectrometers 104 and the LHRs 108. Computing device 116 may be configured to receive a leak detection data feed and a background detection data feed. Computing device 116 may be configured to perform any analysis of said data feeds as described herein. Computing device 116 may be configured to generate one or more signals based on the analysis. For example and without limitation, computing device 116 may be configured to generate a detection signal based on the analysis.

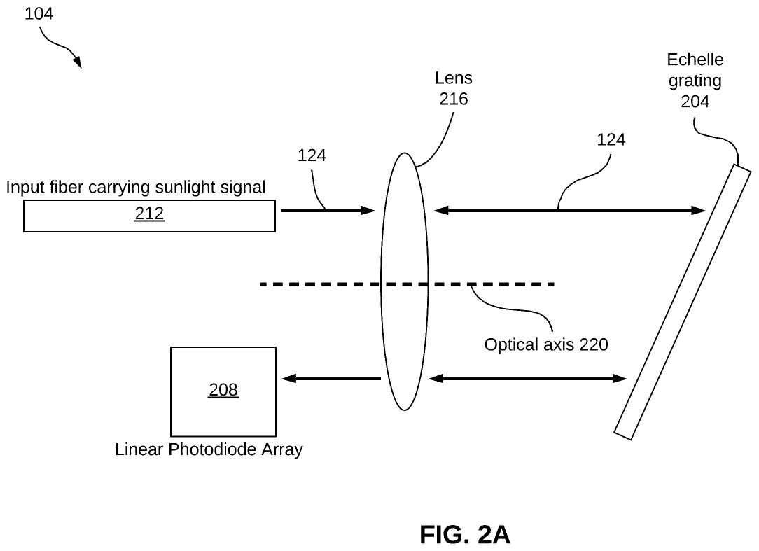

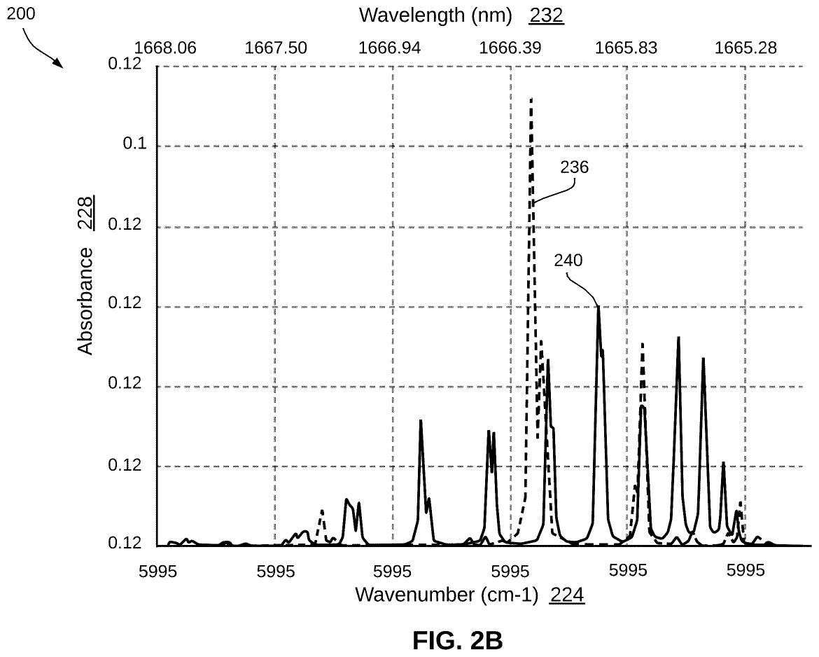

Referring now to FIG. 2, an exemplary schematic representation of a spectrometer is shown. An echelle grating 204 is shown in schematic view, and the illustrated embodiment should not be taken to imply any methodology or configuration of grooves, blaze or other characteristics from this representation. Any echelle grating or any other type of diffracting grating as discussed herein or known in the art may be utilized in any one or more spectrometers 104 described herein. Any number, dimension or configuration of grooves is considered to be disclosed herein. In various embodiments, echelle grating 204 may employ echelle grating in Littrow configuration using ~10th order. In various embodiments, a linear photodiode array 208 may be utilized to detect light 124 (represented by single-headed and double-headed arrows) from the echelle grating 204. In various embodiments, an input fiber 212 may be configured to carry light 124 (sunlight) into the spectrometer.

In various embodiments, one or more lenses 216 may be present at any point within the system. For example and without limitation, there may be a lens 216 upstream of the input fiber 212, before or after the echelle grating 204 or at any point surrounding the photodiode array 208. For example and without limitation, a lens 216 such as a microscope objective may be incorporated to increase the output image size to match the pitch of the photodiode linear array 208, which may be a 16-channel linear array. In various embodiments, as shown in FIG. 2, the photodiode array 208 may be disposed at a distance under the optical axis 220, with the input fiber 212 disposed at an equal distance above the optical axis 220. A retroreflecting optic such as a right-angle prism may be used to pass the incident light from the grating twice or more to improve the resolution of the spectrometer by the number of times the grating is illuminated. In certain embodiments, the right-angle prism may be moved repetitively in the dispersion plane of the grating to scan the dispersed light spectrum across a single element detector which may be a photodiode or a fiber-coupled photodiode. Alternatively, the grating may be repetitively and slightly rotated about an axis perpendicular to the dispersion plane of the grating to achieve wavelength scanning. However, since the grating is relatively large and heavy relative to the right-angle prism, rotating the grating can only be done relatively slowly, limiting the signal-to-noise ratio of the spectrometer data.

Referring back now to FIG. 1, LHR 108 may be any LHR as described herein. LHR 108 may be configured to provide accurate background measurement and removal of background methane 132. In various preferred embodiments, system 100 includes a single LHR 108 to measure the background methane 132 accurately.

Sappey et al. (International Application Publication No. 2022/192247, fully incorporated by reference herein, hereinafter “Sappey”) introduced the idea of using laser heterodyne radiometry for leak detection, in a configuration in which multiple LHR sensors could be used to find a leak using triangulation and other spectrally related location algorithms. The configuration of FIG. 1, and related embodiments (which use an LHR for detection of background levels of methane or other gases and a grating spectrometer for detection of the leak itself) benefit from the strengths of each technology: high spectral resolution for the LHR and high achievable SNR (and low cost) for the spectrometer to provide a solution that is significantly better than each technology individually.

In various embodiments, represented in FIG. 1, a single LHR 108 may be configured to remove the effect of background methane 132 on the measurements provided by one or more spectrometers 104. In various embodiments, system 100 may include one LHR 108 background detection location to remove the effect of background methane on the measurements provided by an array of grating-based spectrometers 104, the background detection location may include one more or LHRs 108. In various embodiments, more than one LHR 108 may be used at the same background detection location In various embodiments, LHR 108 can be located 1-3 kilometers (km) from the leak detection location and may be utilized to measure and remove background methane 132 data. In various embodiments, more than one LHR 108 may be used at a plurality of background detection locations, such as one LHR 108 at each of two background detection locations. In various embodiments an array of LHR 108 may be utilized at one or more locations or background detection locations.

LHR 108 may operate according to the description in Sappey. LHR 108 may operate by interfering a solar signal with an optical signal, the solar signal generated by a light source such as the sun. In various embodiments, the light detector that receives the solar signal from a light source may be configured to generate an electrical signal in response to the solar signal. The optical signal may be generated by a local oscillator or in various embodiments, a laser. LHR 108 may produce this signal by one or more fixed frequency or tunable lasers, driven by one or more drivers and with one or more electrical components configured to control the beam.

An embodiment involves generating, at LHR 108, a light signal with one or more frequencies associated with a spectral line of a gas-phase species of interest, such as ozone, carbon dioxide, methane, nitrous oxide, water, or dichlorodifluoromethane. The linewidth of the light signal may be less than the spectral width of the species' spectral line, and the free-space wavelength of the light signal may be between 1630 nm and 1680 nm when the species is methane.

For example, LHR 108 may generate an absorption lineshape that determines the absorption spectrum from one or more signals. The embodiment may involve determining the altitude of a gaseous plume by fitting pressure-dependent absorption lineshape functions to the absorption spectrum as described in Sappey.

In various embodiments, LHR 108 may provide an altitude data feed or determine the altitude of a gaseous plume, including a gaseous plume of methane, by comparing the absorption spectrum to a plurality of reference absorbance spectra of the species at different atmospheric pressures. For example, LHR 108 may determine the altitude by comparing the absorption spectrum to the aforementioned plurality of reference absorbance spectra of the species, which are used as fitting parameters.

In various embodiments, LHR 108 may be any LHR as described or otherwise known in the art. In various embodiments, LHR 108 may be used to take measurements, such as historical data with time, date, and location information, and store said data in a database 112. The LHR 108 may be configured to constantly or periodically take measurements when commanded by one or more users or automated system and then store all or a subset of the measurement data in database 112. In various embodiments, LHR 108 may be configured to store data regarding any weather phenomena, sunlight characteristics or other data associated with the time, date and environmental location of the measurement area. In various embodiments, a web of LHR 108 may be utilized around a given area, each LHR 108 taking measurements associated with the location of the specific LHR 108, and all data or a subset of the data from all the LHRs 108 may be stored in one or more databases 112.

In various embodiments, system 100 may utilize stored data from database 112 when an LHR 108 is not present or not desired to be used real time. In various embodiments, an off-site detection location LHR 108 may be commanded to take measurements and provide data to the system 100. In various embodiments, LHR 108, or an LHR 108 facility may not be necessary, if data from a nearby LHR 108 or stored data from said nearby LHR 108 may be used.

For example, and without limitation, the data from the LHR, instead of being used to locate and quantify a leak, may then be used to measure the profile of background methane 132 as a function of altitude in the atmosphere so its influence can be removed from the data from spectrometer 104, which may be contaminated by the background methane 132 and not have sufficient spectral resolution to fit and remove the background accurately. The LHR 108 may be configured to operate on the Q(6) spectral feature or, in some cases, the nearby Q(10) spectral feature to avoid absorption saturation from the background methane. The LHR may be particularly suited to this task due to its high spectral resolution (1-2 pm). This mode of operation differs from various embodiments because the LHR 108 operates on the Q(6) feature of methane at 1665.966 nm or the Q(10) spectral feature of methane at 1667.135 nm to avoid saturation effects.

Referring now to FIG. 2B, an exemplary representation of an absorption spectrum of electromagnetic radiation associated with water and methane is shown by a plot 200 generated from light 124 from light source 120, for example. In various embodiments, at least one LHR 108 and at least one spectrometer may be configured to detect methane and water background, as shown in FIG. 2B. The X-axis corresponds to wavenumber 224 (bottom of plot 200) and the corresponding wavelength 232 (top of plot 200) of light 124. The Y-axis represents absorption 228 of the electromagnetic radiation of the light 124. In various embodiments as described herein, LHR 108, in addition to measuring and subtracting the methane background 132, may alternatively or additionally measure the background of one or more elements, compounds or generally, gases present in the atmosphere.

FIG. 2B shows two traces. The trace 236 shows a HITRAN-simulated water absorption spectrum in the spectral region of interest (1.665-1.668 nm) at a concentration of 2%, a temperature of 280 K, a pressure of 0.5 atm., for a path length of 1 km. The trace 240 shows a HITRAN simulation of the methane absorption spectrum at a concentration of 2 ppm (280 K, P=0.5 atm., L=1 km). As can be seen, the spectral features of water lie close to the Q(6) spectral feature (240), but the water does not interfere. As represented by spectral feature (240) shown in FIG. 2B, with the high resolution afforded by the LHR 108, the water and methane features are well-separated and resolved. However, at the lower spectral resolution of the spectrometer (~40 pm), water absorption can overlap the Q(6) feature presenting an unwanted background interference. The water concentration vs. altitude determined by the LHR 108 can be used to remove the unwanted water interference in the spectrometer signal.

FIG. 2B. is merely an exemplary representation of the absorption due to water on an extremely humid day. In various embodiments, the absorption may be altered based on the humidity present in the atmosphere that day, over that measurement period, or instantaneously at the time of measurement. In various embodiments, the LHR 108 may operate on the Q(6) feature at ~6002.5 cm⁻¹, but can easily be tuned to either of the large water peaks. In various embodiments, one or more systems and users may occasionally tune over to either of the large water absorption features of 236 in the region to get a measurement. That measurement will allow the subtraction of the water concentration from the grating spectrometer measurements.

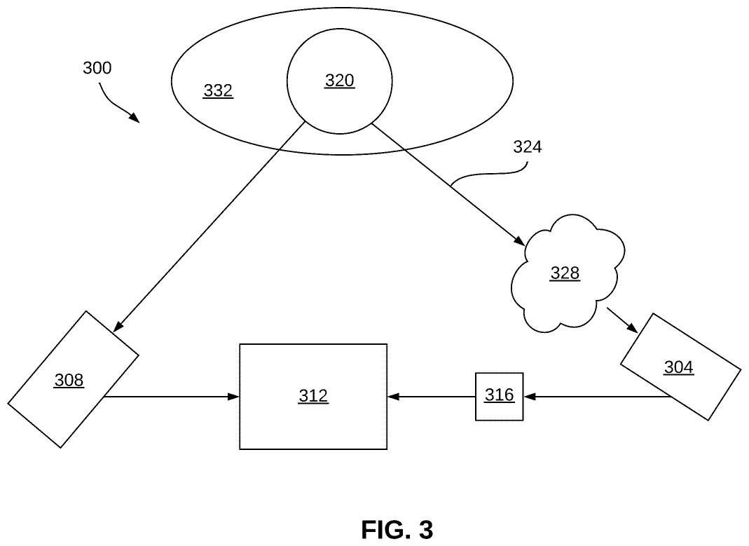

Referring now to FIG. 3, a schematic representation of a gaseous leak detection system 300 is depicted. Gaseous leak detection system 300 includes a single grating-based spectrometer 304 configured to stare at the light source, in this case, the sun 320. The grating-based spectrometer 304 is configured to receive light 324 (represented by arrows) after it transits a methane plume 328. The grating-based spectrometer 304 is configured to diffract the light into a linear photodiode array in accordance with any of the methodologies described herein. In various embodiments, a movable mirror such as provided by a galvanometer bar code scanner or piezoelectric bender can scan the wavelength-dispersed light across a single InGaAs detector or a single-mode, fiber-optic coupled InGaAs detector. Grating-based spectrometer 304 may be configured to track the sun 320 across its path in the sky. Gaseous leak detection system 300 includes a single LHR 308. LHR 308 may be any LHR as described herein.

In embodiments, LHR 308 is configured to receive light 324 that does not transit the methane plume 328 to account for the background methane 332 that the spectrometer could not adequately discern due to resolution parameters. LHR 308 is configured to measure and remove said background methane 332 spectra from the spectrometers 304 measurements, thereby allowing the gaseous leak detection system 300 to accurately detect methane plume 328. In certain embodiments, the LHR 308 will operate on the Q(6) spectral feature or, in some cases, the nearby Q(10) spectral feature to avoid absorption saturation from the background methane. The LHR may be particularly suited to this task due to its high spectral resolution (1-2 pm).

With continued reference to FIG. 3, gaseous leak detection system 300 may include one or more computing devices 316. Computing device 316 may be consistent with any description of a computing device herein. Computing device 316 may be one or more processors communicatively connected to the spectrometers 304 and the LHRs 308. In various embodiments, computing device 316 may be configured to receive electrical or optical signals output by one or more of the spectrometers 304 and LHRs 308. Computing device 316 may be configured to generate commands and transmit those commands to one or more of the spectrometers 304 and the LHRs 308. Computing device 316 may be configured to receive a leak detection data feed and a background detection data feed. Computing device 316 may be configured to perform any analysis of said data feeds as described herein. Computing device 316 may be configured to generate one or more signals based on the analysis. For example, and without limitation, computing device 316 may be configured to generate a detection signal based on the analysis.

Most significantly, computing device 316 may use machine learning (ML) algorithms to compare methane leak plume data and/or background detection data feeds at a given time to historical methane leak plume data and/or background detection data feeds at the same location to data from the previous day, week, month or year. The one or more ML algorithms may be configured to compare background detection data feeds over some period of time in the past, for example, weeks, months, years, or more, to determine whether a change in one or more data feeds represent normal changes over time of day or some other variable. For example, and without limitation, the ML algorithm may be configured to determine if a change in data is normal or may represent a gaseous leak.

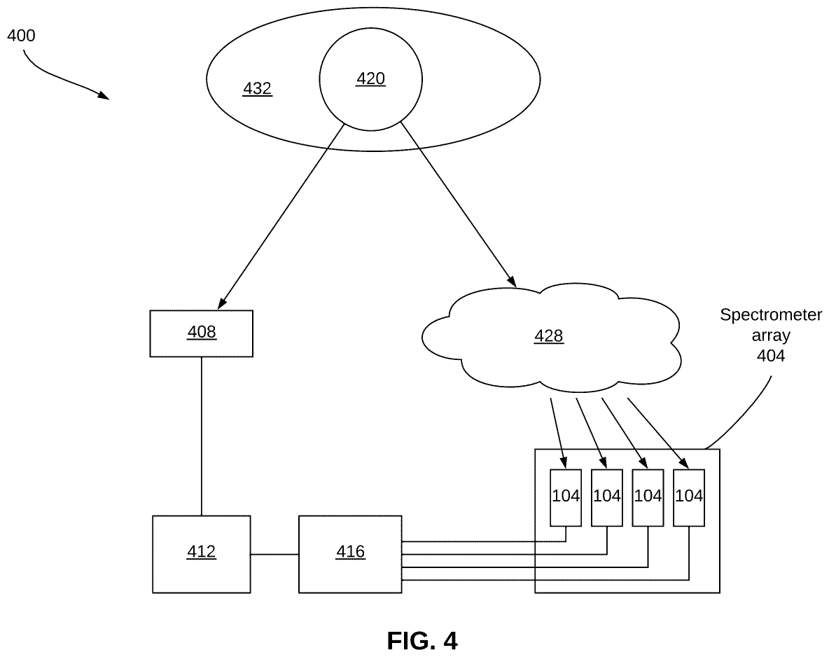

Referring now to FIG. 4, a schematic representation of the gaseous leak detection system 400 is shown depicted. As shown in FIG. 4, gaseous leak detection system 400 includes an array 404 of grating-based spectrometer 104, rather than a single spectrometer. Further, an array of grating spectrometers is not the same thing as a detector array. An array of grating spectrometers is multiple spectrometers placed at different locations. A detector array is (potentially) part of the grating spectrometer. The array 404 is configured to stare at the light source, in this case, the sun 420. Array 404 may be configured to receive sunlight 424 after it transits a methane plume 428. The array 404 is configured to diffract the light into a linear photodiode array in accordance with any of the methodologies described herein. Array 404 may be configured to track the sun 420 across its path in the sky. Array 404 may be located on one site or multiple sites. In various embodiments, array 404 may be remotely or individually located, wherein each spectrometer 104 may be located in different geographic locations. In various embodiments, the remotely located array 404 may utilize triangulation to locate the methane plume 428. In various embodiments, array 404 may utilize Global Positioning Systems (GPS) to locate the methane plume 428 once detected.

Gaseous leak detection system 400 includes a single LHR 408. LHR 408 may be any LHR as described herein. LHR 408 may be configured to receive sunlight 424 that does not transit the methane plume 428 to account for the background methane 432 that the spectrometer could not adequately discern due to resolution parameters. In various embodiments, LHR 408 may be configured to measure and remove said background methane 432 spectra from the array of spectrometers 404, rather than from a single spectrometer, thereby removing background methane 432 measurements, thus allowing the gaseous leak detection system 400 to accurately detect methane plume 428. As with gaseous leak detection system 400, the LHR data may be used in background methane subtraction, as described above.

With continued reference to FIG. 4, gaseous leak detection system 400 may include one or more computing devices 416. Computing device 416 may be consistent with any description of a computing device herein. Computing device 416 may be one or more processors communicatively connected to the spectrometers 404 and the LHRs 408. In various embodiments, computing device 416 may be configured to receive electrical or optical signals output by one or more of the spectrometers 404 and LHRs 408. Computing device 416 may be configured to generate commands and transmit those commands to one or more of the spectrometers 404 and the LHRs 408. Computing device 416 may be configured to receive a leak detection data feed and a background detection data feed. Computing device 416 may be configured to perform any analysis of said data feeds as described herein. Computing device 416 may be configured to generate one or more signals based on the analysis. For example, and without limitation, computing device 416 may be configured to generate a detection signal based on the analysis. Computing device 416 may use machine learning algorithms to compare current methane leak data and/or background detection data feeds to historical data (including background detection data feeds) at the same location to determine if a change in the methane concentration has occurred relative to historical data thereby helping to determine if a leak has occurred.

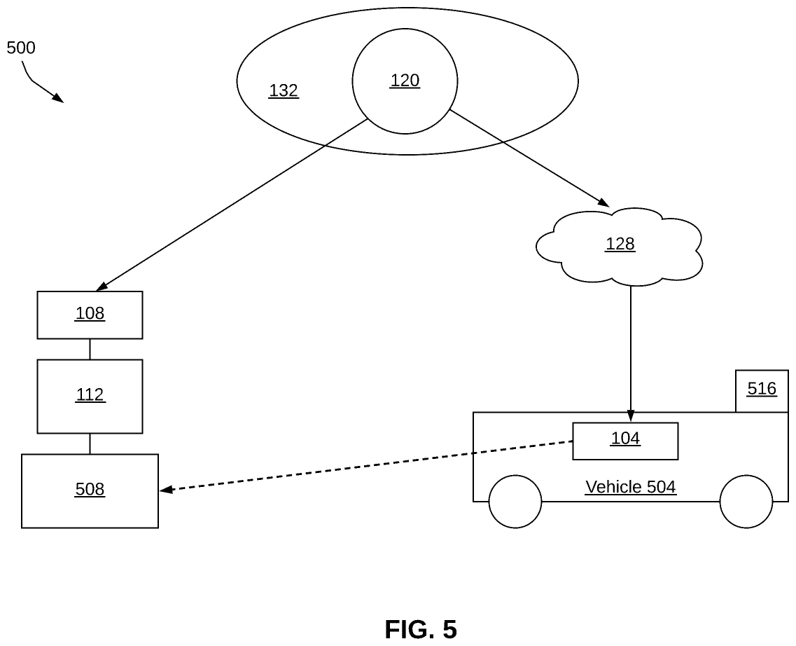

Referring now to FIG. 5, a schematic representation of a gaseous leak detection system 500 in accordance with the disclosed subject matter. Gaseous leak detection system 500 may be similar to any system or detector as described herein. Gaseous leak detection system 500 may include a remotely located LHR 108 or historical data associated with background methane (which may be the same as background methane 132). LHR 108 may be configured to stare or measure light from a light source 120, such as the sun. LHR 108 may be located at a facility or background detection location, or an array of LHR 108 facilities or background detection locations. In various embodiments, LHR 108 or database 112 is communicatively connected to a remote computing device 508 to which it can transmit and receive digital information, such as any absorption data or background methane measurements.

In various embodiments, gaseous leak detection system 500 includes spectrometer 104 may be any spectrometer 104 as described herein, namely a grating-based spectrometer. In various embodiments, spectrometer 104 may be mounted on a vehicle 504, which may be a ground-based drone. In various embodiments, vehicle 504 may be a user-controlled vehicle, whether remotely controlled through radio control or onboard piloting, such as spectrometer-mounted passenger vehicle. In various embodiments, vehicle 504 may be an autonomous vehicle configured to move based on a variety of environmental, weather or other topographical parameters. In various embodiments, vehicle 504 may be semi-autonomous, wherein vehicle 504 may operate according to a set of instructions such as a prewritten experimental procedure or geographical set points. In various embodiments, vehicle 504 may track the path of the sun 120 across the sky, turn to track the sun 120 or rotate or tilt the spectrometer 104.

In various embodiments, vehicle 504 may include sensor suite 516. Sensor suite 516 may include one or more sensors configured to detect or measure environmental, weather, electrical or optical phenomena to inform one or more operation modes of the vehicle 504 and/or spectrometer 104. For example, and without limitation, sensor suite 516 may include an anemometer. For the purposes of this disclosure, an anemometer is configured to measure wind speed and direction. The anemometer may be a cup anemometer, vane anemometer, hot-wire anemometer, ultrasonic anemometer, or an acoustic resonance anemometer. Sensor suite 516 may include one or more thermometers or otherwise temperature sensing sensors.

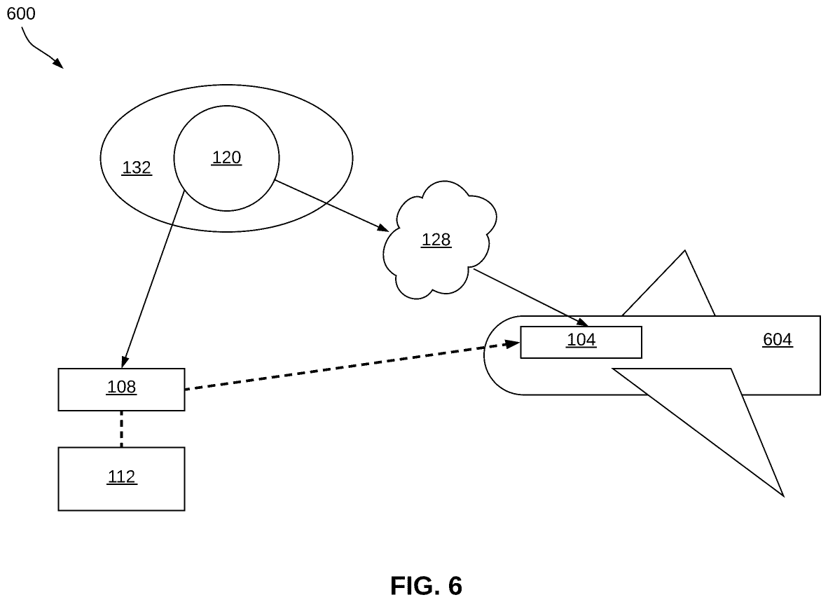

Referring now to FIG. 6, a schematic representation of a gaseous leak detection system 600 in accordance with the disclosed subject matter. Gaseous leak detection system 600 may be similar to any system or detector as described herein. Gaseous leak detection system 600 may include a remotely located LHR 108 or historical LHR 108 data associated with background methane (which may be the same as background methane 132). LHR 108 may be configured to stare or measure light from a light source 120, such as the sun. LHR 108 may be located at a facility or background detection location, or an array of LHR 108 facilities or background detection locations. In various embodiments, LHR 108 or database 112 is communicatively connected to a remote computing device 608 to which it can transmit and receive digital information, such as any absorption data or background methane measurements.

In various embodiments, detector 600 includes spectrometer 104 may be any spectrometer 104 as described herein, namely a grating-based spectrometer. In an example, spectrometer 104 may be mounted on an aerial vehicle 604. In various embodiments, vehicle 504 may be an aerial drone. In various embodiments, aerial vehicle 604 may be a user-controlled vehicle, whether remotely controlled through radio control or onboard piloting, such as spectrometer-mounted aircraft. In various embodiments, aerial vehicle 604 may be an autonomous vehicle configured to move based on a variety of environmental, weather, or other topographical parameters. In various embodiments, aerial vehicle 604 may be semi-autonomous, wherein aerial vehicle 604 may operate according to a set of instructions such as a prewritten experimental procedure or geographical set points. In various embodiments, aerial vehicle 604 may track the path of the sun 120 across the sky using a gimbal mount in the drone, and or fly in a pattern mirroring the sun's path or another flight pattern.

In various embodiments, aerial vehicle 604 may be a fixed wing aircraft such as a remote-controlled airplane, glider, or the like. In various embodiments, aerial vehicle 604 may be a rotor-based aircraft such as a helicopter, quadcopter, or multi-copter. In various embodiments, aerial vehicle 604 may include a sensor suite that may include one or more sensors configured to detect or measure environmental, weather, electrical or optical phenomena to inform one or more operation modes of the aerial vehicle 604 and/or spectrometer 104. For example, and without limitation, sensor suite may include an anemometer. Sensor suite may include one or more thermometers or otherwise temperature sensing sensors.

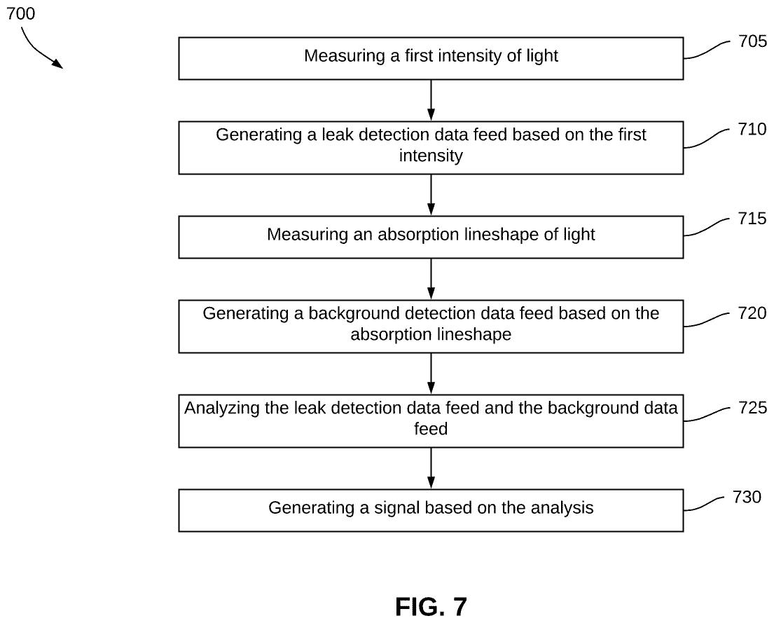

Referring now to FIG. 7, method 700 for detecting a gaseous leak is presented in flow chart form. Method 700, at step 705, includes measuring a first intensity of light. Measuring a first intensity of light may include measuring the first intensity of light via a spectrometer, such as an echelle grating spectrometer. In various embodiments, the spectrometer may be configured to stare at a light source, which may be the sun, the moon, stars, or another celestial body, like one or more planets. In various embodiments, more than one spectrometer as described herein or known in the art may be employed to stare at the sun in a single location or a plurality of locations. In various embodiments, the spectrometer may be fixed and the sun passes through its field of view. In various embodiments, the spectrometer may be configured to track the sun through its path in the sky. In various embodiments, the spectrometer may be configured to look at the sun periodically or continuously throughout the measurement time window.

In various embodiments, the first intensity of light may be an absorption of light over one or more portions of the electromagnetic spectrum, namely NIR and MIR. Measuring the first intensity of light from the light source associated with a gaseous leak via one or more spectrometers. In various embodiments, one or more spectrometers may measure the absorption of electromagnetic radiation, such as near infrared (NIR) or mid-infrared (MIR) associated with methane. In various embodiments, one or more electromagnetic measurements may be associated with one or more gases present in the atmosphere. In various embodiments, one or more spectrometers may be configured to detect a certain gas or the same gas, for example, gaseous methane. In various embodiments, one or more spectrometers may be configured to detect a certain spectrum of electromagnetic radiation. In various embodiments, one or more spectrometers may be configured to operate on the NIR spectrum or the MIR spectrum. In various embodiments, one or more spectrometers may be configured to communicate with one or more computing devices to receive or transmit data.

With continued reference to FIG. 7, method 700, at step 710 includes generating a leak detection data feed based on the first intensity. Generating the leak detection data feed may include one or more electronic or optical signals corresponding to the intensity, absorption, or another characteristic of the light from the sun. Generating the leak detection data feed may include one or more components such as amplifiers, computing devices, power electronics, or the like to generate an electrical or optical signal. In various embodiments, the leak detection data feed may be the absorption of light from the sun as it transits a gas leak. In various embodiments, the gas leak may be a methane plume.

With continued reference to FIG. 7, method 700, at step 715, includes measuring an absorption lineshape of light from the light source. Measuring the absorption lineshape of light may include detecting a background characteristic of the light from the light source associated with a background gas presence in the atmosphere. In various embodiments, one or more LHR are configured to detect the presence of a background methane present in the Earth's atmosphere consistent with the entirety of this disclosure. In various embodiments, the absorption lineshape of light may be associated with light transiting any gaseous element or compound present, for example water vapor, in the atmosphere at a specific altitude.

Measuring the absorption lineshape of light may be an absorption of light over one or more portions of the electromagnetic spectrum, namely NIR and MIR. In various embodiments, one or more LHRs may be configured to communicate with one or more computing devices to receive or transmit data.

Measuring the absorption lineshape may be performed by one or more LHRs. A LHR may be configured to stare at the light source. In various embodiments, there may be a single LHR at a single background detection location. In various embodiments, LHR at the background detection location may be configured to stare at the sun. In various embodiments, there may be a single LHR at a plurality of background detection locations, each configured to stare at the sun. In various embodiments, there may be more than one LHR at a single background detection location or a plurality of LHRs at a plurality of background detection locations configured to stare at the sun and operate in concert. The LHR may be any LHR as described herein or known in the art.

With continued reference to FIG. 7, method 700, at step 720, includes generating a background detection data feed based on the absorption lineshape. Generating the background detection data feed may include one or more electronic or optical signals corresponding to the intensity, lineshape, absorption or another characteristic of the light from the sun. Background detection data feed may be generated by one or more processors or components consistent with this disclosure to generate the data feed in response to the measured quantity, such as absorption lineshape. Generating the background detection data feed may include one or more components such as amplifiers, computing devices, power electronics, or the like in order to generate an electrical or optical signal. In various embodiments, the background detection data feed may be the absorption of light from the sun as it transits a background gas in the atmosphere not within the gas leak. In various embodiments, the background gas may be water vapor. In various embodiments, the background gas may be methane.

With continued reference to FIG. 7, method 700, at step 725, includes analyzing the leak detection data feed and the background data feed. Analyzing the leak detection data feed and the background detection data feed includes comparing the leak detection data feed and the background detection data feed. In various embodiments, analyzing the leak detection data feed and the background detection data feed includes removing the background detection data feed from the leak detection data feed using a mathematical operation, such as but not limited to subtraction.

A grating-based spectrometer of sufficiently small size to be practical may have limited spectral resolution and may struggle to remove the effect of background methane at higher altitudes where low-pressure conditions cause the absorption lineshape to be very narrow requiring a higher-resolution technique to quantify. In various embodiments, analyzing the leak detection data feed and the background detection data feed includes receiving an environmental data feed, which may include wind direction, wind velocity, temperature, and or humidity, along with the background detection data feed from the leak detection data feed.

The environmental data feed may be utilized to adjust geographical parameters, detection or measurement of a physical parameter or the like. For example and without limitation, the wind speed and wind direction may be fed to the one or more computing devices, and when or if the methane plume is detected, geographical considerations may be applied such that the gas leak is accurately located. For example and without limitation, the methane plume may be blowing in a direction at a certain speed, so the system may detect a leak and accurate locate its origin based on the environmental data feed.

With continued reference to FIG. 7, method 700, at step 730, includes generating a signal based on the analysis indicating the presence or absence of anomalous methane concentrations. In various embodiments, the signal is a detection signal or non-detection signal. Deciding if a signal is a detection signal or non-detection signal is determined by analyzing the leak detection data feed and the background detection data feed on the basis of a mathematical operation including but not limited to subtraction. A detection signal is where the leak detection data feed exceeds the background detection data feed, indicating the presence of anomalous methane, for instance. A non-detection signal is where the leak detection data feed does not exceed the background detection data feed, contra-indicating the presence of anomalous methane. In various embodiments, a detection signal includes a location of a gas leak. In various embodiments, the gas leak is a methane plume. In various embodiments, the detection signal includes a detection location. In various embodiments, the leak detection signal is compared against historical data such as previous leak detection signals, leak detection data feeds, background detection data feeds, or other data at that location to determine if a change in leak status has occurred over time. The algorithm to accomplish this comparison may involve the use of machine learning (ML) and/or artificial intelligence (AI). In various embodiments, the detection signal includes an altitude of a gas leak. In various embodiments, after a detection signal indicates the presence of anomalous methane, one or more computing devices may be configured to receive environmental data, such as wind direction and velocity, and output a detection location of the methane leak based on the environmental data. In various embodiments, the detection location of the methane leak will use the geographical data feed to map the location of the methane leak. In various embodiments, one or more computing devices are configured to transmit said geographical data feed, which may be one or more geographical maps, coordinates or other location information, to a user or another computing device.

Analysis to determine a quantity of the gas leaked in a suitable unit, such as kg/hr, based on the leak data feed, background data feed, and environmental data feed from the gaseous leak detection system will be processed using inversion algorithms. Inversion algorithms will utilize the leak data feed, background data feed, and environmental data feed, and using a pre-constructed data model, will invert model's matrix to determine the model's best-fit leak parameters. Using statistical tests, such as a least-squares fit test, the model's best-fit leak parameters will used to determine the quantity of gas leaked.

The systems and method as described herein may be utilized to monitor other NIR and MIR absorbing gases such as CO2 and H2O at different wavelengths. Those of ordinary skill in the art would appreciate that methane has multiple transitions throughout the NIR and MIR that could be used for detection instead of the illustrative exemplary overtone transition at 1.66 microns, such as a fundamental transition at approximately 3.3 microns (3300 nm).

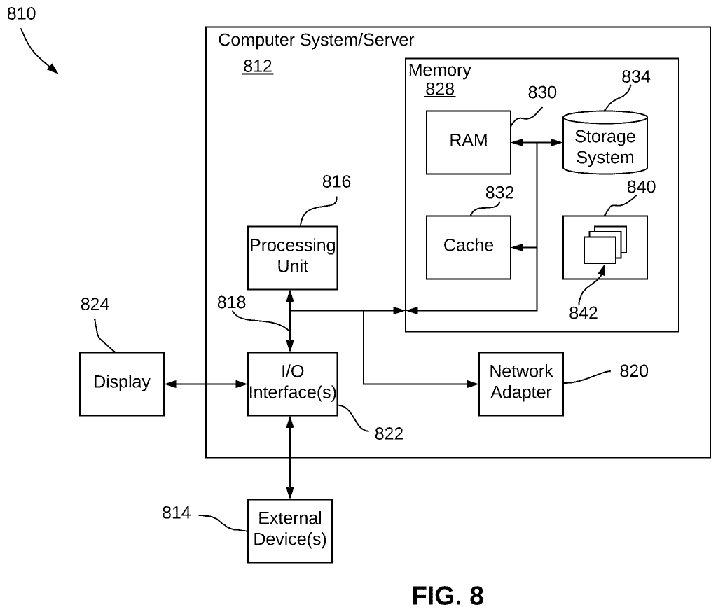

Referring now to FIG. 8, a schematic of an example of a computing node is shown. Computing node 810 is only one example of a suitable computing node and is not intended to suggest any limitation as to the scope of use or functionality of embodiments described herein. Regardless, computing node 810 is capable of being implemented and/or performing any of the functionality set forth hereinabove.

In computing node 810 there is a computer system/server 812, which is operational with numerous other general purpose or special purpose computing system environments or configurations. Examples of well-known computing systems, environments, and/or configurations that may be suitable for use with computer system/server 812 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 812 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 812 in computing node 810 is shown in the form of a general-purpose computing device. The components of computer system/server 812 may include, but are not limited to, one or more processors or processing units 816, a system memory 828, and a bus 818 that couples various system components including system memory 828 to processor 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 812 typically includes a variety of computer system readable media. Such media may be any available media that is accessible by computer system/server 812, and it includes both volatile and non-volatile media, removable and non-removable media.

System memory 828 can include computer system readable media in the form of volatile memory, such as random-access memory (RAM) 830 and/or cache memory 832. Computer system/server 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions of embodiments of the disclosure.

Program/utility 840, having a set (at least one) of program modules 842, may be stored in memory 828 by way of example, and not limitation, as well as an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments as described herein.

Computer system/server 812 may also communicate with one or more external devices 814 such as a keyboard, a pointing device, a display 824, etc. ; one or more devices that enable a user to interact with computer system/server 812; and/or any devices (e.g., network card, modem, etc.) that enable computer system/server 812 to communicate with one or more other computing devices. Such communication can occur via Input/Output (I/O) interfaces 822. Still yet, computer system/server 812 can communicate with one or more networks such as a local area network (LAN), a general wide area network (WAN), and/or a public network (e.g., the Internet) via network adapter 820. As depicted, network adapter 820 communicates with the other components of computer system/server 812 via bus 818. It should be understood that although not shown, other hardware and/or software components could be used in conjunction with computer system/server 812. Examples, include, but are not limited to microcode, device drivers, redundant processing units, external disk drive arrays, RAID systems, tape drives and data archival storage systems, among others.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein may include an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which may include one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the disclosed subject matter is described herein in terms of certain exemplary embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

In certain embodiments, the spectrometer described herein includes a diffraction grating as the dispersive element; however, other dispersive element such as prisms, volume phase holograms, Bragg gratings, and holographic gratings and the like could also be used.

Likewise, the spectrometer includes a wavelength tuning element that scans the dispersed light past a single element detector and doubles the resolution of the spectrometer; however, other tuning mechanisms could be used including but not limited to galvanometer mirrors, a tunable filter such as an acousto-optic tunable filter, and movement of the diffraction grating itself. Also, the wavelength scanning element could be replaced by an array detector which is included in the scope of the present disclosure. Spectrometer geometries other than a Littrow mounting are also possible such as a Littman-Metcalf design or a Czerny-Turner design and are also within the scope of the present disclosure. Broadband light sources other than the sun such as LEDs, superluminescent diodes and optical amplifiers are also within the scope of the current disclosure.

Certain embodiments may further include the following features.
1. A gaseous leak detection system, including:
a spectrometer configured to measure a first intensity of light from a light source and generate a leak detection data feed, wherein the spectrometer is emplaced at a leak detection location;
a laser heterodyne radiometer (LHR), wherein the LHR is configured to measure an absorption lineshape from the light source and generate a background data feed, wherein the LHR is emplaced at a background detection location; and
a computing device, wherein the computing device is configured to analyze the leak detection data feed and the background data feed to detect the presence of a gas leak.
2. The gaseous leak detection system of item 1, including two or more spectrometers.
3. The gaseous leak detection system of any one of items 1-2, wherein the spectrometer includes a diffraction grating.
4. The gaseous leak detection system of any one of items 1-3, wherein the background data feed is stored as a historical background data feed in a datastore.
5. The gaseous leak detection system of any one of items 1-4, wherein the computing device analyzes the leak detection data feed and the historical background detection data feed.
6. The gaseous leak detection system of any one of item 1-5, wherein the computing device analyzes contemporaneous leak detection data feed and the background detection data feed.
7. The gaseous leak detection system of any one of items 1-6, wherein analyzing the leak detection data feed and the background detection data feed includes utilizing at least one machine learning algorithm to compare the leak detection data feed and the background detection data feed at the leak detection location to historical data at the leak detection location.
8. The gaseous leak detection system of any one of items 1-7, wherein the background data feed includes location data and time data corresponding to the background detection location and a time of measurement.
9. The gaseous leak detector of any one of items 1-8, wherein the spectrometer includes an echelle grating in a Littrow configuration.
10. The gaseous leak detector of any one of items 1-9, wherein the spectrometer includes a photodiode.
11. The gaseous leak detector of any one of items 1-10, wherein the photodiode is an indium gallium arsenide (InGaAs) photodiode array.
12. The gaseous leak detection system of any one of items 1-11, wherein the gas leak is a methane plume.
13. The gaseous leak detection system of any one of items 1-12, wherein the background data feed detects the presence of methane.
14. The gaseous leak detection system of any one of items 1-13, wherein the background data feed detects the presence of water vapor.
15. The gaseous leak detector of any one of items 1-14, wherein the computing device is configured to receive an environmental data feed.
16. The gaseous leak detector of any one of items 1-15, wherein the environmental data feed is a wind direction and a wind velocity.
17. The gaseous leak detector of any one of items 1-16, wherein the environmental data feed is a temperature.
18. The gaseous leak detector of any one of items 1-17, wherein the environmental data feed is a humidity.
19. The gaseous leak detection system of any one of items 1-18, wherein the spectrometer is mounted on a ground-based vehicle.
20 The gaseous leak detection system of any one of items 1-19, wherein the ground-based vehicle is an autonomous vehicle.
21. The gaseous leak detection system of any one of items 1-20, wherein the spectrometer is mounted on an aerial vehicle.
22. The gaseous leak detection system of any one of items 1-21, wherein the aerial vehicle is a fixed-wing aircraft.
23. The gaseous leak detection system of any one of items 1-22, wherein the aerial vehicle is an autonomous drone.
24. The gaseous leak detection system of any one of items 1-23, wherein the autonomous drone is a multicopter.
25. A method for detecting gaseous leaks, the method including:
measuring a first intensity of light from a light source using a spectrometer emplaced at a leak detection location;
generating a leak detection data feed based on the first intensity of light, measuring an absorption lineshape of light from the light source using a laser heterodyne radiometer (LHR) emplaced at a background detection location;
generating a background data feed based on the absorption lineshape of the light;
analyzing, by a computing device, the leak detection data feed and the background data feed; and
generating a signal based on the analysis.
26. The method for detection of a gaseous leak of item 25, including two or more spectrometers.
27. The method for detection of a gaseous leak of any one of items 25-26, wherein the spectrometer includes a diffraction grating.
28. The method for detection of a gaseous leak of any one of items 25-27, wherein the background data feed is stored as a historical background data feed in a datastore.
29. The method for detection of a gaseous leak of any one of items 25-28, wherein the computing device analyzes the leak detection data feed and the historical background detection data feed.
30. The method for detection of a gaseous leak of any one of items 25-29, wherein the computing device analyzes contemporaneous leak detection data feed and the background detection data feed.
31. The method for detection of a gaseous leak of any one of items 25-30, wherein analyzing the leak detection data feed and the background detection data feed includes utilizing at least one machine learning algorithm to compare the leak detection data feed and the background detection data feed at the leak detection location to historical data at the leak detection location.
32. The method for detection of a gaseous leak of any one of items 25-31, wherein the background data feed includes location data and time data corresponding to the background detection location and a time of measurement.
33. The method for detection of a gaseous leak of any one of items 25-32, wherein the spectrometer includes an echelle grating in a Littrow configuration.
34. The method for detection of a gaseous leak of any one of items 25-33, wherein the spectrometer includes a photodiode.
35. The method for detection of a gaseous leak of any one of items 25-34, wherein the spectrometer includes a single photodiode with a scanning mirror.
36. The method for detection of a gaseous leak of any one of items 25-35, wherein the photodiode is an indium gallium arsenide (InGaAs) photodiode array.
37. The method for detection of a gaseous leak of any one of items 25-36, wherein the gas leak is a methane plume.
38. The method for detection of a gaseous leak of any one of items 25-37, wherein the background data feed detects the presence of methane.
39. The method for detection of a gaseous leak of any one of items 25-38, wherein the background data feed detects the presence of water vapor.
40. The method for detection of a gaseous leak of any one of items 25-39, wherein the computing device is configured to receive an environmental data feed.
41. The method for detection of a gaseous leak of any one of items 25-40, wherein the environmental data feed is a wind direction and a wind velocity.
42. The method for detection of a gaseous leak of any one of items 25-41, wherein the environmental data feed is a temperature.
43. The method for detection of a gaseous leak of any one of items 25-42, wherein the environmental data feed is a humidity.
44. The method for detection of a gaseous leak of any one of items 25-43, wherein the spectrometer is mounted on a ground-based vehicle.
45. The method for detection of a gaseous leak of any one of items 25-44, wherein the ground-based vehicle is an autonomous vehicle.
46. The method for detection of a gaseous leak of any one of items 25-45, wherein the spectrometer is mounted on an aerial vehicle.
47. The method for detection of a gaseous leak of any one of items 25-46, wherein the aerial vehicle is a fixed-wing aircraft.
48. The method for detection of a gaseous leak of any one of items 25-47, wherein the aerial vehicle is an autonomous drone.
49. The method for detection of a gaseous leak of any one of items 25-48, wherein the autonomous drone is a multicopter.
50. The method for detection of a gaseous leak of any one of items 25-49, wherein the signal is a detection signal.
51. The method for detection of a gaseous leak of any one of items 25-50, wherein the signal is a non-detection signal.
52. The method for detection of a gaseous leak of any one of items 25-51, further including determining a location of the gas leak based on the environmental data feed and the light source.
53. The method for detection of a gaseous leak of any one of items 25-52, further including generating a geographical data feed, the geographical data feed based on leak detection data feed, the background detection data feed and the environmental data feed.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms-even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding”-whether explicitly discussed or not-and, conversely, were there only disclosure of the act of “protruding”, such a disclosure should be understood to encompass disclosure of a “protrusion”. Such changes and alternative terms are to be understood to be explicitly included in the description.

1. A gaseous leak detection system, comprising:
at least one spectrometer configured to measure a first intensity of light from a light source and generate a leak detection data feed, wherein the spectrometer is emplaced at a leak detection location; and
a laser heterodyne radiometer (LHR), wherein the LHR is configured to measure an absorption lineshape from the light source and generate a background data feed, wherein the LHR is emplaced at a background detection location.

2. The gaseous leak detection system of claim 1, further comprising a computing device,
wherein the computing device is configured to analyze the leak detection data feed and background data feed to detect presence of a gas leak.

3. The gaseous leak detection system of claim 1,
wherein the at least one spectrometer includes at least one of a diffraction grating and an echelle grating in a Littrow configuration.

4. The gaseous leak detection system of claim 1,
wherein the at least one spectrometer includes a photodiode and a wavelength scanning element.

5. The gaseous leak detection system of claim 4,
wherein the photodiode is an indium gallium arsenide (InGaAs) photodiode array.

6. The gaseous leak detection system of claim 1,
wherein the spectrometer is configured to be mounted on a mobile vehicle including at least one of a fixed-wing aircraft, drone, and multicopter.

7. The gaseous leak detection system of claim 6,
wherein the mobile vehicle is one of an autonomous vehicle and a piloted vehicle.

8. A method for detecting gaseous leaks, the method comprising:
measuring a first intensity of light from a light source using at least one spectrometer emplaced at a leak detection location;
generating a leak detection data feed based on the first intensity of light,
measuring an absorption lineshape of light from the light source using a laser heterodyne radiometer (LHR) emplaced at a background detection location;
generating a background data feed based on the absorption lineshape of the light from the light source;
analyzing, by a computing device, the leak detection data feed and the background data feed; and
generating a signal based on the analyzing.

9. The method of claim 8,
wherein a methane plume is located at the leak detection location, and
wherein the background data feed includes presence of background methane.

10. The method of claim 8,
wherein the background data feed includes at least one of historical background data feed and contemporaneous background data feed, and
wherein the background data feed includes location data and time data corresponding to the background detection location.

11. The method of claim 10,
wherein analyzing by the computing device includes at least one of removing the contemporaneous background data feed from the leak detection feed and removing the historical background data feed from the leak detection data feed.

12. The method of claim 8,
wherein analyzing the leak detection data feed and the background detection data feed includes utilizing at least one machine learning algorithm to compare the leak detection data feed and the background detection data feed at the leak detection location to historical data at the leak detection location.

13. The method of claim 8,
wherein the signal is one of a detection signal and a non-detection signal, and
wherein analyzing the leak detection data feed and the background detection data feed includes using at least one machine learning algorithm to correlate the leak detection data feed and the background detection data feed.

14. The method of claim 8,
wherein the computing device is configured to receive an environmental data feed including at least one of wind direction, wind velocity, temperature, and humidity.

15. The method of claim 14,
further comprising determining a location of a gaseous leak based on the environmental data feed using at least one of triangulation and inversion.

16. The method of claim 14, further comprising:
receiving the environmental data feed from multiple sensors;
processing at least one of the environmental data feed, leak detection data feed, and background detection data feed using inversion algorithms, and
determining a quantity of gas leaked in a suitable unit based on the leak data feed, the background data feed, and the environmental data feed so processed.

17. A gaseous leak detection system, comprising:
a spectrometer placed at a potential leak location, the spectrometer including a photodiode and at least one of a diffraction grating and an echelle grating in a Littrow configuration;
a laser heterodyne radiometer (LHR) placed at a background detection location; and
a computing device configured for receiving and analyzing data from the spectrometer and the LHR,
wherein the spectrometer is configured to generate a leak detection data feed from light intensity measured from a light source,
wherein the LHR is configured to generate a background data feed from an absorption lineshape measured from the light source, and
wherein the computing device is configured for receiving and analyzing the leak detection data feed and the background data feed to determine presence of a gas leak.

18. The gaseous leak detection system of claim 17, wherein the light source is at least one of sun, moon, a star, a planet, and an artificial source of electromagnetic radiation.

19. The gaseous leak detection system of claim 17, further comprising:
a sensor system for generating an environmental data feed,
wherein the environmental data feed includes at least one of wind direction, wind velocity, and humidity, and
wherein the computing device is further configured to receive the environmental data feed from the sensor system.

20. The gaseous leak detection system of claim 19, wherein the computing device is further configured to use the leak detection data feed, the background data feed, and the environmental data feed to determine at least one of a location and a quantity of gas leaked from the gas leak, if determined to be present.
